(19) United States
(12) Patent Application Publication
(10) Pub. No.: US 2023/0352856 A1
(43) Pub. Date: Nov. 2, 2023

(54) ELECTRIC WIRE WITH TERMINAL

(71) Applicant: Yazaki Corporation, Tokyo (JP)

(72) Inventor: Tomohiko WATANABE, Shizuoka (JP)

(73) Assignee: Yazaki Corporation, Tokyo (JP)

(21) Appl. No.: 18/304,622

(22) Filed: Apr. 21, 2023

(30) Foreign Application Priority Data
Apr. 28, 2022 (JP) 2022-074199

(51) Int. Cl. H01R 4/18; H01R 4/70; H01R 11/11

(52) U.S. Cl. CPC H01R 4/185; H01R 4/70; H01R 11/11

(57) ABSTRACT

An electric wire with a terminal includes an electric wire and a terminal. The electric wire includes a core wire and an insulation coating covering the core wire. The terminal includes a coating crimp portion crimped to an outer periphery of the insulation coating and having a front end and a rear end. A chamfer is provided on at least one of an edge of the front end facing the insulation coating or an edge of the rear end facing the insulation coating.

### CROSS-REFERENCE TO RELATED APPLICATIONS

The present application is based on and claims the benefit of priority from the prior Japanese Patent Application No. 2022-074199, filed on Apr. 28, 2022, the entire contents of which are incorporated by reference herein.

### TECHNICAL FIELD

The disclosure relates to an electric wire with a terminal.

### BACKGROUND

An electric wire with a terminal disclosed in JP 2020-191196 A is provided with an electric wire in which a core wire is covered with an insulation coating, and a terminal having a core wire crimp portion connected to the core wire of the electric wire and a coating crimp portion connected to the insulation coating. In the electric wire with a terminal, the tips of a pair of crimp pieces of the coating crimp portion are overlapped and crimped to the insulation coating of the electric wire.

### SUMMARY OF THE INVENTION

In the electric wire with a terminal described above, when the coating crimp portion of the terminal is crimped to the insulation coating of the electric wire, the insulation coating may be damaged by the inner edges of the front end and rear end of the pair of crimp pieces of the coating crimp portion.

The disclosure is directed to an electric wire with a terminal that is capable of easily and reliably preventing damage to the insulation coating of the electric wire caused by the ends of the coating crimp portion when the coating crimp portion of the terminal is connected to the insulation coating of the electric wire.

An electric wire with a terminal in accordance with some embodiments includes an electric wire and a terminal. The electric wire includes a core wire and an insulation coating covering the core wire. The terminal includes a coating crimp portion crimped to an outer periphery of the insulation coating and having a front end and a rear end. A chamfer is provided on at least one of an edge of the front end facing the insulation coating or an edge of the rear end facing the insulation coating.

The above configuration makes it possible to provide an electric wire with a terminal that is capable of easily and reliably preventing damage to the insulation coating of the electric wire caused by the ends of the coating crimp portion when the coating crimp portion of the terminal is connected to the insulation coating of the electric wire.

### BRIEF DESCRIPTION OF DRAWINGS

FIG. 1 is a perspective view illustrating an example of an electric wire with a terminal according to a first embodiment.

FIG. 2 is a perspective view illustrating a state of a terminal of FIG. 1 before the terminal is connected to the electric wire.

FIG. 3 is a plan view of the electric wire with a terminal of FIG. 1.

FIG. 4 is a cross-sectional view taken along the line IV-IV in FIG. 3.

FIG. 5 is a cross-sectional view taken along the line V-V in FIG. 2.

FIG. 6 is a cross-sectional view taken along the line VI-VI in FIG. 4.

FIG. 7 is a cross-sectional view of an electric wire with a terminal according to a second embodiment taken along the line V-V in FIG. 2.

### DETAILED DESCRIPTION OF THE INVENTION

Hereafter, an electric wire with a terminal 1 according to embodiments will be described in detail with reference to the drawings.

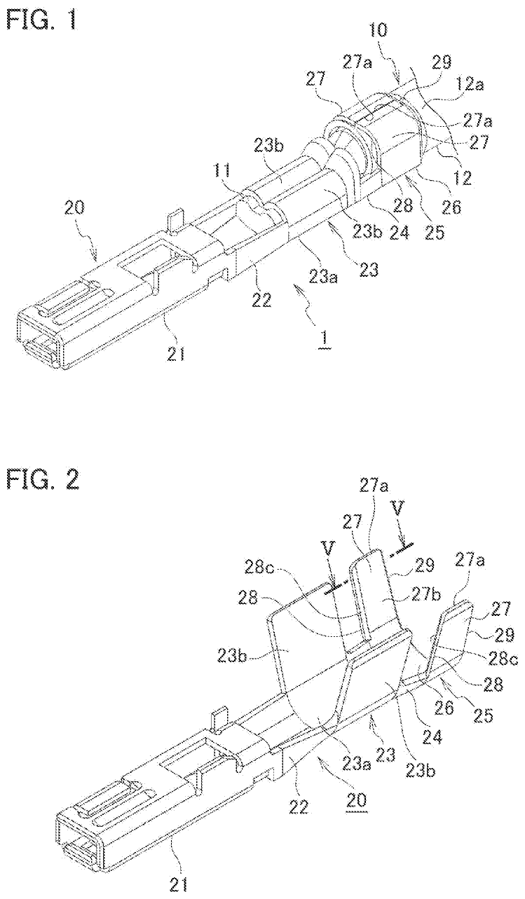

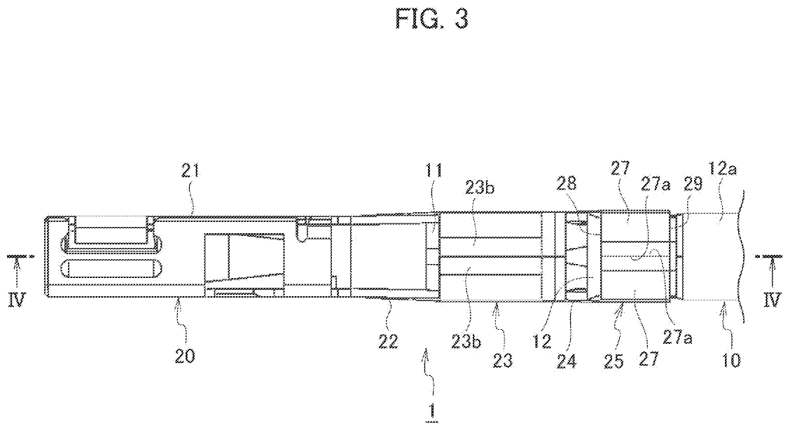

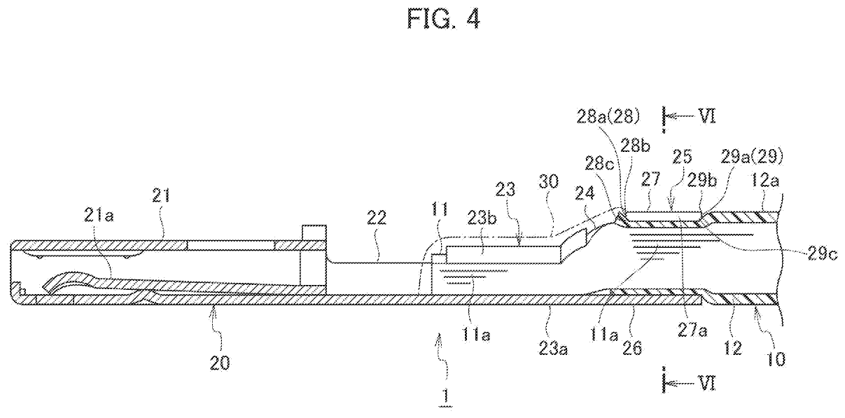

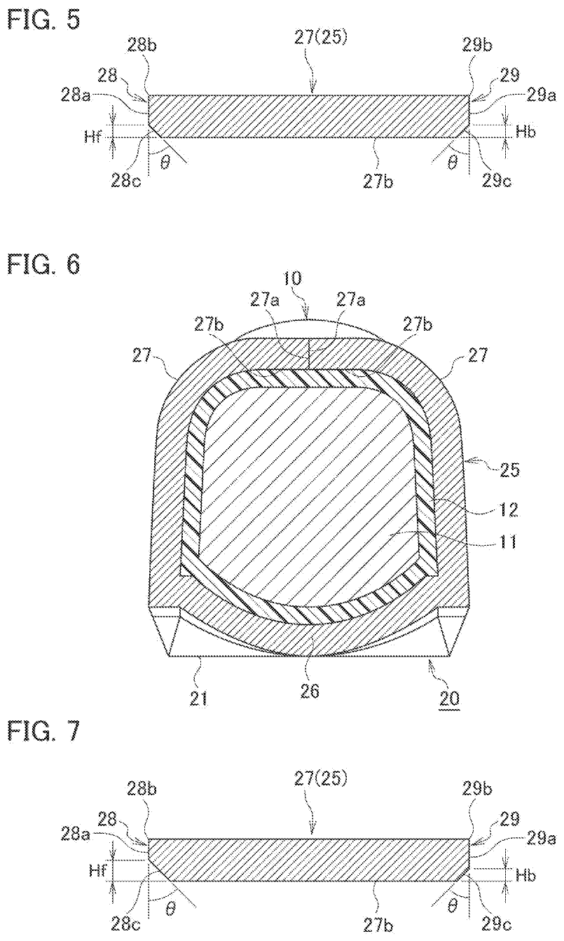

FIG. 1 is a perspective view illustrating an example of the electric wire with a terminal 1 according to a first embodiment. FIG. 2 is a perspective view illustrating a state of a terminal before the terminal 20 is connected to the electric wire. FIG. 3 is a plan view of the electric wire with a terminal 1. FIG. 4 is a cross-sectional view taken along the line IV-IV in FIG. 3. FIG. 5 is a cross-sectional view taken along the line V-V in FIG. 2. FIG. 6 is a cross-sectional view taken along the line VI-VI in FIG. 4.

As illustrated in FIGS. 1, 3 and 4, the electric wire with a terminal 1 includes: an electric wire 10 having a core wire 11 and an insulation coating 12 covering the core wire 11; and a terminal 20 having a core wire crimp portion 23 crimped to the core wire 11 and a coating crimp portion 25 crimped to the outer periphery 12a of the insulation coating 12.

As illustrated in FIG. 4, the core wire 11 of the electric wire 10 is composed of a plurality of strands 1 la which are made of aluminum or aluminum alloy, and the insulation coating 12 is removed at a specified length to expose the core wire 11 at the terminal portion of the electric wire 10. A pair of crimp pieces 23b of the core wire crimp portion 23 of the terminal 20 are crimped to the exposed core wire 11 using a crimper, an anvil, or the like which are not illustrated.

As illustrated in FIG. 2, the terminal 20 is a female-type crimp terminal and is formed into a predetermined shape by press-forming a conductive metal plate. More specifically, as illustrated in FIGS. 1 to 3, the terminal 20 includes: a box-shaped connection portion 21; the core wire crimp portion 23 configured to crimp the core wire 11 exposed from the insulation coating 12 of the electric wire 10, facing the terminal portion; and the coating crimp portion 25 configured to crimp the insulation coating 12.

As illustrated in FIG. 4, the box-shaped connection portion 21 has an elastic contact piece 21a inside, which is electrically connected to a tab of a male-type counterpart terminal (not illustrated herein). As illustrated in FIGS. 1 and 4, the connection portion 21 and the core wire crimp portion 23 are connected by a U-shaped front connection piece 22. The core wire crimp portion 23 and the coating crimp portion 25 are connected by a U-shaped front connection piece 24.

As illustrated in FIGS. 1, 2 and 4, the core wire crimp portion 23 has a bottom plate 23a on which the core wire 11 is placed, and has the pair of crimp pieces 23b which are provided continuously in a U-shape from both sides of the bottom plate 23a and crimp the core wire 11. As illustrated in FIGS. 1 and 3, the pair of crimp pieces 23b are crimped to the core wire 11 in a state where the tips of the pair of crimp pieces 23b are inserted into the core wire 11 of the electric wire 10 and abutted against each other (in contact with each other).

As illustrated in FIGS. 1, 2 and 4, the coating crimp portion 25 has a bottom plate 26 on which the insulation coating 12 is placed, and has a pair of crimp pieces 27 which are provided continuously in a U-shape from both sides of the bottom plate 26 and crimp the insulation coating 12. As illustrated in FIGS. 1 and 6, the pair of crimp pieces 27 are crimped to the outer periphery 12a of the insulation coating 12 of the electric wire 10 in a state where the tip surfaces 27a of the pair of crimp pieces 27 are abutted against each other (in contact with each other).

As illustrated in FIGS. 2 and 5, in the pair of crimp pieces 27, inclined planes 28c and 29c having flat surfaces (chamfers) are respectively formed on inner edges 28b and 29b of the end surface 28a of the front end 28 and the end surface 29a of the rear end 29 (facing the insulation coating 12). More specifically, as illustrated in FIG. 2, the inclined planes 28c of the front ends 28 of the pair of crimp pieces 27 are formed over the entire width of the crimp pieces 27 from the U-shaped front connection piece 24 side to the tip surfaces 27a side. In addition, the inclined planes 29c of the rear ends 29 of the pair of crimp pieces 27 are formed over the entire periphery from the tip surface 27a of one crimp piece 27 to the tip surface 27a of the other crimp piece 27 through the bottom plate 26. Further, each inclined plane 28c and 29c of the front end 28 and the rear end 29 is chamfered in such a way as to be inclined at an angle θ of 30 degrees to 60 degrees with respect to each end surface 28a and 29a. In the first embodiment, the inclined planes 28c and 29c having flat surfaces are inclined at an angle θ of 45 degrees.

As illustrated in FIG. 5, in the pair of crimp pieces 27, a height Hf of the inclined plane 28c of the front end 28 from the inner surface 27b of each crimp piece 27 and a height Hb of the inclined plane 29c of the rear end 29 from the inner surface 27b of each crimp piece 27 are the same (Hf=Hb).

As illustrated in FIG. 4, the terminal 20 is covered with an anticorrosion resin 30 in a range from the front end 28 of the coating crimp portion 25 to the core wire 11 positioned in front of the core wire crimp portion 23, in a state where the core wire crimp portion 23 is crimped to the core wire 11 and the coating crimp portion 25 is crimped to the insulation coating 12. That is, the above range from the front end 28 of the coating crimp portion 25 to the core wire 11 positioned in front of the core wire crimp portion 23 has liquid thermoplastic resin or the like applied thereto and is covered with the anticorrosion resin 30, and the exposed core wire 11 is thereby subjected to anticorrosion treatment.

As described above, according to the electric wire with a terminal 1 of the first embodiment, when connecting the coating crimp portion 25 of the terminal 20 to the insulation coating 12 of the electric wire 10, the inner surfaces 27b of the crimp pieces 27 and the inclined planes 28c and 29c of the front end 28 and rear end 29 come into surface contact with all portions of the insulation coating 12. This surface contact makes it possible to reduce the compressive/shear strain of the insulation coating 12 caused by the coating crimp portion 25, and sharp edges do not come into contact with the insulation coating 12. Thus, it is possible to prevent damage to the insulation coating 12 caused by the front end 28 and rear end 29 of the coating crimp portion 25 easily and reliably.

The inner edges 28b and 29b of the end surface 28a of the front end 28 and the end surface 29a of the rear end 29 of the pair of crimp pieces 27 are chamfered at the same angles. Thus, it is possible to standardize the workpiece settings of the terminal mold, thereby making it possible to reduce the cost of the cutting process.

Both ends of the front end 28 and the rear end 29 of the pair of crimp pieces 27 are chamfered to form the inclined planes 28c and 29c having flat surfaces For this reason, the forming workability is good when the terminal 20 is formed by press-forming a conductive metal plate.

FIG. 7 is a cross-sectional view of a second embodiment taken along the line V-V in FIG. 2.

The electric wire with a terminal 1 according to the second embodiment differs from the electric wire with a terminal 1 according to the first embodiment in that, in the crimp pieces 27, the height Hf of the inclined plane 28c of the front end 28 from the inner surface 27b is formed greater than the height Hb of the inclined plane 29c of the rear end 29 from the inner surface 27b (Hf>Hb). Since other configurations are the same as those of the first embodiment, the same components are denoted by the same reference numerals, and a detailed description thereof is omitted.

In the electric wire with a terminal 1 according to the second embodiment, the front end 28 of the crimp piece 27 shears the insulation coating 12 more than the rear end 29 of the crimp piece 27, and thus the height Hf of the inclined plane 28c of the front end 28 is formed greater (Hf>Hb) than the height Hb of the inclined plane 29c of the rear end 29. This makes it possible to further reduce the compression/shear strain of the insulation coating 12 caused by the front end 28 of the crimp piece 27. Accordingly, when the coating crimp portion 25 of the terminal 20 is connected to the insulation coating 12 of the electric wire 10, damage to the insulation coating 12 caused by the front end 28 and rear end 29 of the coating crimp portion 25 can be more reliably prevented.

In the above embodiments, the coating crimp portion 25 is crimped to the insulation coating 12 in a state where the tip surfaces 27a of the pair of crimp pieces 27 are abutted against each other (in contact with each other); however, the present invention is not limited thereto. For example, the coating crimp portion 25 may be crimped to the insulation coating 12 by overlapping one crimp piece 27 on the tip of the other crimp piece 27.

In the above embodiments, a chamfer may also be formed on the inner edge of the upper end of the U-shaped front connection piece 24 that connects the core wire crimp portion 23 and the coating crimp portion 25 with each other.

In the above embodiments, the chamfers 28c and 29c are formed on the inclined planes having flat surfaces; however, the present invention is not limited thereto. For example, the chamfers 28c and 29c may be formed on the inclined planes having arc-shaped surfaces (rounded shape).

In the above embodiments, the core wire 11 of the electric wire 10 having the terminal 20 crimped thereto is made of aluminum; however, the present invention is not limited thereto. For example, a core wire other than aluminum, such as a core wire made of copper or copper alloy, may be crimped by the pair of crimp pieces 23b of the core wire crimp portion 23.

In the above embodiments, the chamfers 28c and 29c are formed on the inner edges 28b and 29b of both the front end 28 and the rear end 29, respectively; however, the present invention is not limited thereto. For example, the chamfer may be formed only on the inner edge 29b of the rear end 29. In this case, it is possible to reliably prevent the insulation coating 12 from being damaged and broken at a position away from the front end 28 of the coating crimp portion 25.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electric wire with a terminal comprising:
an electric wire including a core wire and an insulation coating covering the core wire; and
a terminal including a coating crimp portion crimped to an outer periphery of the insulation coating and having a front end and a rear end,
wherein a chamfer is provided on at least one of an edge of the front end facing the insulation coating or an edge of the rear end facing the insulation coating.

2. The electric wire with a terminal according to claim 1, wherein the chamfer is provided on each of the edge of the front end facing the insulation coating and the edge of the rear end facing the insulation coating.

3. The electric wire with a terminal according to claim 2, wherein
the chamfer of each of the front end and the rear end is an inclined plane having a flat surface, and
a height of the inclined plane of the front end from an inner surface of the coating crimp portion and a height of the inclined plane of the rear end from the inner surface of the coating crimp portion are the same.

4. The electric wire with a terminal according to claim 2, wherein
the chamfer of each of the front end and the rear end is an inclined plane having a flat surface, and
a height of the inclined plane of the front end from an inner surface of the coating crimp portion is greater than a height of the inclined plane of the rear end from the inner surface of the coating crimp portion.

5. The electric wire with a terminal according to claim 3, wherein
the inclined plane of the front end is inclined at an angle of 30 to 60 degrees with respect to an end surface of the front end, and
the inclined plane of the rear end is inclined at an angle of 30 to 60 degrees with respect to an end surface of the rear end.

6. The electric wire with a terminal according to claim 1, wherein
the coating crimp portion includes:
a bottom plate on which the insulation coating is placed; and
a pair of crimp pieces provided continuously from both sides of the bottom plate and configured to crimp the insulation coating, the front end of the coating crimp portion having the chamfer is front ends of the pair of crimp pieces, and
the rear end of the coating crimp portion having the chamfer is rear ends of the pair of crimp pieces.

7. The electric wire with a terminal according to claim 6, wherein the pair of crimp pieces are crimped to the insulation coating in a state where tip surfaces of the pair of crimp pieces are abutted against each other.

8. The electric wire with a terminal according to claim 1, wherein
the terminal further includes a core wire crimp portion crimped to the core wire, and
the electric wire with a terminal further comprises an anticorrosion resin covering a range from the front end of the coating crimp portion to the core wire positioned in front of the core wire crimp portion, in a state where the core wire crimp portion is crimped to the core wire and the coating crimp portion is crimped to the insulation coating.
